(19) United States
(12) Patent Application Publication
(10) Pub. No.: US 2024/0206692 A1
(43) Pub. Date: Jun. 27, 2024

(54) HANDHELD BLOWING-SUCTION INTEGRATED DUST REMOVER AND DUST REMOVER

(71) Applicant: Shenzhen Mfine Technology Co., Ltd., Shenzhen (CN)

(72) Inventor: Hongchun GAN, Shenzhen (CN)

(73) Assignee: Shenzhen Mfine Technology Co., Ltd., Shenzhen (CN)

(21) Appl. No.: 18/599,226

(22) Filed: Mar. 8, 2024

Related U.S. Application Data
(63) Continuation-in-part of application No. PCT/CN2022/108906, filed on Jul. 29, 2022.

(30) Foreign Application Priority Data
Sep. 13, 2021 (CN) 202122212752.2

(51) Int. Cl. A47L 9/32; A47L 5/14; A47L 5/24; A47L 9/02; A47L 9/12; A47L 9/24

(52) U.S. Cl. CPC A47L 9/322; A47L 5/14; A47L 5/24; A47L 9/02; A47L 9/125; A47L 9/248

(57) ABSTRACT

A handheld blowing-suction integrated dust remover includes a main body, a handle, and a drive assembly. A first air vent and a second air vent are respectively formed at two opposite ends of the main body. A ventilating chamber is formed in the main body. Both the first air vent and the second air vent communicate with the ventilating chamber and the outside of the main body. The first air vent and the second air vent are respectively connected to elongated air tubes. The handle is connected to the main body. The handle is formed into an included angle with the main body to be held conveniently. The drive assembly is provided in the ventilating chamber and can utilize the elongated air tubes at two sides to drive the first air vent and the second air vent to suck air and blow air.

### CROSS REFERENCE TO THE RELATED APPLICATIONS

This application is the continuation-in-part application of International Application No. PCT/CN2022/108906, filed on Jul. 29, 2022, which is based upon and claims priority to Chinese Patent Application No. 202122212752.2, filed on Sep. 13, 2021, the entire contents of which are incorporated herein by reference.

### TECHNICAL FIELD

The present disclosure relates to the technical field of handheld dust removers, and in particular to a handheld blowing-suction integrated dust remover and a dust remover.

### BACKGROUND

An existing handheld dust remover is provided with only one air vent. When used in cooperation with an air tube, the dust remover can only suck dust through one air tube, or can only blow dust through one air tube. Consequently, use scenarios of the dust remover are limited.

### SUMMARY

The present disclosure provides a handheld blowing-suction integrated dust remover and a dust remover, to solve the problem that a use scenario of the dust remover is limited due to a fact that the dust remover is provided with only one air vent, and when used in cooperation with an air tube, the dust remover can only suck dust through one air tube, or can only blow dust through one air tube.

In order to solve the above technical problem, the present disclosure employs the following technical solutions:

According to a first aspect, the present disclosure provides a handheld blowing-suction integrated dust remover, including:
a main body, where a first air vent and a second air vent are respectively formed at two opposite ends of the main body, a ventilating chamber is formed in the main body, both the first air vent and the second air vent communicate with the ventilating chamber and the outside of the main body, and the first air vent and the second air vent are respectively connected to elongated air tubes;
a handle connected to the main body, where the handle is formed into an included angle with the main body to be held conveniently; and
a drive assembly provided in the ventilating chamber and configured to utilize the elongated air tubes at two sides to drive one of the first air vent and the second air vent to suck air, and the other of the first air vent and the second air vent to blow air.

According to a second aspect, the present disclosure provides a handheld blowing-suction integrated dust remover, including:
a main body, where a first air vent and a second air vent are respectively formed at two opposite ends of the main body, a ventilating chamber is formed in the main body, and both the first air vent and the second air vent communicate with the ventilating chamber and the outside of the main body;
a handle connected to the main body, where the handle is formed into an included angle with the main body to be held conveniently;
a drive assembly provided in the ventilating chamber and configured to drive one of the first air vent and the second air vent to suck air, and the other of the first air vent and the second air vent to blow air; and
an air tube, where the air tube is elongated, an end of the air tube is detachably connected to the first air vent, and the air tube can further be separated from the first air vent and detachably connected to the second air vent.

According to a third aspect, the present disclosure provides a dust remover, including:
a main body, where a first air vent and a second air vent are respectively formed at two opposite ends of the main body, a ventilating chamber is formed in the main body, and both the first air vent and the second air vent communicate with the ventilating chamber and the outside of the main body; and
a handle, where the handle is rotatably connected to the main body, such that the handle can be switched between a first position and a second position; when the handle is located at the first position, a central axis of the first air vent is formed into an obtuse angle with a central axis of the handle, and an end of the handle away from the main body is adjacent to a side with the second air vent; when the handle is located at the second position, a central axis of the second air vent is formed into an obtuse angle with the central axis of the handle, and the end of the handle away from the main body is adjacent to a side with the first air vent; and at the first position and the second position, the central axis of the handle, a central axis of the main body, and a rotating axis for rotation of the handle relative to the main body are coplanar.

According to a fourth aspect, the present disclosure provides a dust remover, including:
a main body, where a first air vent and a second air vent are respectively formed at two opposite ends of the main body, a ventilating chamber is formed in the main body, and both the first air vent and the second air vent communicate with the ventilating chamber and the outside of the main body; and
a handle, where the handle is rotatably connected to the main body, such that the handle can be switched between a first position and a second position; when the handle is located at the first position, a central axis of the first air vent is formed into an obtuse angle with an extension direction of the handle, and an end of the handle away from the main body is adjacent to a side with the second air vent; when the handle is located at the second position, a central axis of the second air vent is formed into an obtuse angle with the extension direction of the handle, and the end of the handle away from the main body is adjacent to a side with the first air vent; and when the handle is switched from one position to the other position in the first position and the second position, a movement track of a central axis of the handle constitutes at least one part of a conical surface.

According to the above technical solutions, embodiments of the present disclosure have at least the following beneficial effects.

In the embodiments of the present disclosure, the first air vent and the second air vent are respectively connected to the elongated air tubes. One of the first air vent and the second air vent sucks the air, while the other of the first air vent and the second air vent blows the air. Hence, the handheld blowing-suction integrated dust remover can be applied to a use environment with dust blowing and dust suction, thereby increasing a use scenario. Meanwhile, since the first air vent and the second air vent are respectively connected to the elongated air tubes, the handheld blowing-suction integrated dust remover can suck the dust or blow the dust in a narrow space, and can be used conveniently.

### BRIEF DESCRIPTION OF THE DRAWINGS

To describe the technical solutions in the embodiments of the present disclosure or in the prior art more clearly, the following briefly describes the drawings required for describing the embodiments or the prior art. Apparently, the drawings in the following description show some embodiments of the present disclosure, and those of ordinary skill in the art may still derive other drawings from structures shown in these drawings without creative efforts.

FIG. 1 is a schematic structural view of a handheld blowing-suction integrated dust remover when a handle is located at a first position according to the present disclosure;

FIG. 2 is a schematic structural view of a handheld blowing-suction integrated dust remover when a handle is located at a second position according to the present disclosure;

FIG. 3 is an exploded structural view of a handheld blowing-suction integrated dust remover according to the present disclosure;

FIG. 4 is an exploded structural view of a main body according to the present disclosure;

FIG. 5 is an exploded structural view of a handheld blowing-suction integrated dust remover according to the present disclosure;

FIG. 6 is an enlarged structural view of A in FIG. 5;

FIG. 7 is a schematic structural view of a connecting protrusive seat according to the present disclosure; and

FIG. 8 is an exploded structural view of a main body according to the present disclosure.

### REFERENCE NUMERALS

1: housing, and 2: handheld blowing-suction integrated dust remover;
10: main body, 11: first end, 12: second end, 13: first air vent, 14: second air vent, 15: main shell, 16: ventilating chamber, 100: connecting groove, 101: clamping protrusive seat, 110: ventilation adapting kit, 1100: first adapting member, 1101: second adapting member, 1102: third adapting member, 1103: adapting nozzle, 1104: second air tube, 120: first air tube, 121: brush member, 122: bristle, 130: body, 1300: stud, 140: connecting protrusive seat, 1400: seat body, 1401: clamping member, 1402: first locating flange, 1403: second locating flange, 1404: first locating groove, 1405: wire hole, 1406: through hole, 1407: second locating groove, 150: drive assembly, 1500: motor, 1501: impeller, 160: protective cover, 1600: protective guard, 170: filter screen, and 180: rear cover; and
20: handle, 200: left half shell, 201: right half shell, 210: mounting seat, 211: mounting groove, 212: clamping groove, 220: locating member, 2200: fixed seat, 2201: first clamping member, 2202: second clamping member, 230: connecting post, 2300: threaded hole, 231: second through hole, 240: control button, 250: circuit board, and 260: antislip stripe.

### DETAILED DESCRIPTION OF THE EMBODIMENTS

The typical implementations embodying the features and advantages of the present disclosure are described in detail below. It should be understood that the present disclosure may have various changes in different implementations, which do not depart from the scope of the present disclosure. The description and drawings herein are essentially used for the purpose of explanation, rather than to limit the present disclosure.

In addition, the terms “first” and “second” are merely intended for a purpose of description, and shall not be understood as an indication or implication of relative importance or implicit indication of a quantity of indicated technical features. Therefore, the features defined by “first” and “second” can explicitly or implicitly include one or more features. In the description of the present disclosure, “multiple” means two or more, unless otherwise specifically defined.

In the description of the present disclosure, it should be noted that, unless otherwise clearly specified, meanings of terms “mount”, “connect with”, and “connect to” should be understood in a broad sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand the specific meanings of the above terms in the present disclosure based on specific situations.

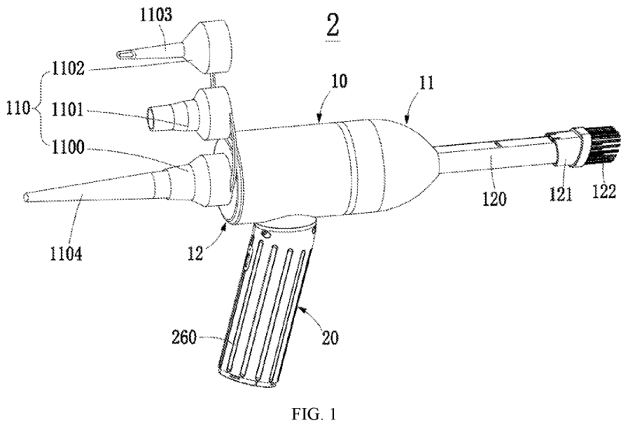

As shown in FIG. 1, the present disclosure provides handheld blowing-suction integrated dust remover 2. The handheld blowing-suction integrated dust remover 2 can blow air or suck air, so as to remove dirt including dust in a narrow space, such as at a corner of a component in a precise instrument. By sucking the air, the dust is absorbed to the handheld blowing-suction integrated dust remover 2. Or by blowing the air, the dust is blown off. The handheld blowing-suction integrated dust remover 2 includes main body 10 and handle 20 that are connected. Two opposite ends of the main body 10 can blow the air or suck the air. The handle 20 can be held by a user to select one end of the main body 10 to remove the dirt. The handle 20 is rotatably connected to the main body 10. When any end of the main body 10 is used, the handle 20 can rotate until a central axis of the handle 20 is formed into an obtuse angle with an air blowing direction or an air sucking direction of the main body 10. The handle 20 is held by the user with a high comfort level and a good user experience.

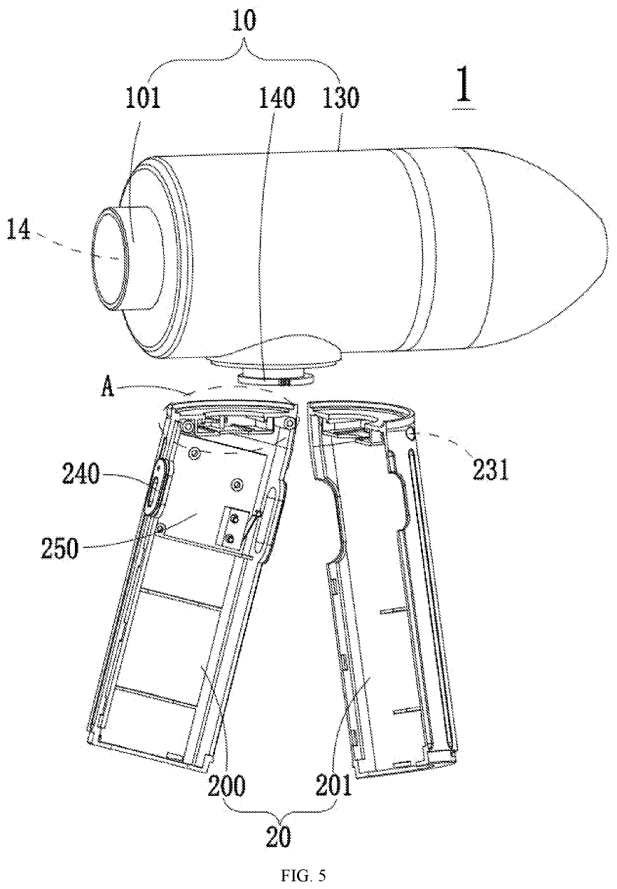

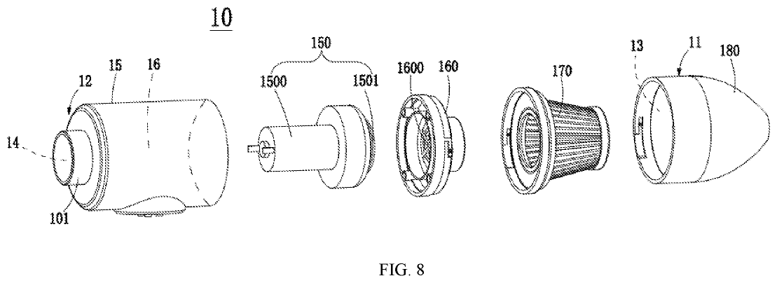

As shown in FIG. 1, FIG. 5 and FIG. 8, the handheld blowing-suction integrated dust remover 2 includes drive assembly 150 and housing 1. The housing 1 includes the handle 20 and the main body 10. The drive assembly 150 includes motor 1500 and impeller 1501. The motor 1500 can drive the impeller 1501 to rotate at a high speed, such that outside air is brought to the main body 10, or an airflow in the main body 10 is discharged to the outside, thereby forming air blowing or air suction.

As shown in FIG. 1 and FIG. 8, the main body 10 includes first end 11 and second end 12 that are opposite to each other. First air vent 13 is formed at the first end 11. Second air vent 14 is formed at the second end 12. Ventilating chamber 16 is formed in the main body 10. Both the first air vent 13 and the second air vent 14 communicate with the ventilating chamber 16 and the outside of the main body 10. The motor 1500 drives the impeller 1501 to rotate, such that the first air vent 13 and the second air vent 14 suck the air or blow the air at the same time, or one of the first air vent 13 and the second air vent 14 blows the air, while the other of the first air vent and the second air vent sucks the air. In an embodiment, the motor 1500 drives the first air vent 13 to suck the air, and the second air vent 14 to blow the air. According to an actual condition, the first end 11 or the second end 12 of the main body 10 can be selected to align at a dust removal position, thereby sucking the dust or blowing the dust off.

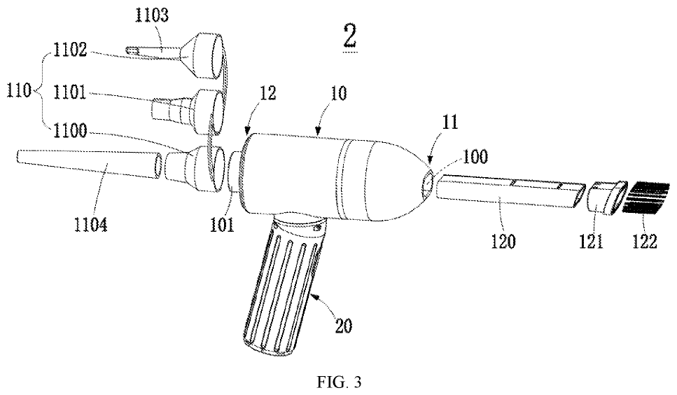

As shown in FIG. 3, in an embodiment, the first end 11 and/or the second end 12 of the main body 10 may be connected to an elongated air tube. The main body 10 can suck the air or blow the air through the air tube. The elongated air tube is stretched into the narrow space conveniently for dust removal. Therefore, the dust is removed more conveniently and effectively. The air tube may be fixedly connected to the main body 10 through welding or an integrally formed structure, and may also be detachably connected to the main body through clamping or threaded connection. In the embodiment, the air tube is detachably connected to the main body 10 through the clamping. Specifically, connecting groove 100 is formed at the first end 11 of the main body 10. The connecting groove 100 extends toward the inside of the main body 10. The connecting groove 100 communicates with the ventilating chamber 16 and the outside of the main body 10. The connecting groove 100 is not limited in shape, and may be circular, rectangular or elliptical. The connecting groove 100 is elliptical in the embodiment. The connecting groove 100 can be cooperatively interlocked with or separated from first air tube 120 having an elliptical cross section. An end of the first air tube 120 away from the main body 10 may be detachably interlocked with brush member 121. An end of the brush member 121 away from the first air tube 120 may be provided with a plurality of bristles 122 along a circumferential direction of the brush member 121. The bristles 122 can be used for hard-to-remove dirt. The brush member 121 is hollow, for ease of ventilation. In cooperation with the bristles 122, the dirt is removed more easily, and the use is convenient. In addition, a side of the brush member 121 away from the first air tube 120 is inclined. All of the bristles 122 may have a same length. That is, a plane of an end of each of the plurality of bristles 122 away from the brush member 121 is also inclined. Therefore, the dirt is removed more carefully and conveniently.

To sum up, in the present disclosure, the first air vent 13 and the second air vent 14 are respectively connected to the elongated air tubes. One of the first air vent 13 and the second air vent 14 sucks the air, while the other of the first air vent and the second air vent blows the air. Hence, the handheld blowing-suction integrated dust remover 2 can be applied to a use environment with dust blowing and dust suction, thereby increasing a use scenario. Meanwhile, since the first air vent 13 and the second air vent 14 are respectively connected to the elongated air tubes, the handheld blowing-suction integrated dust remover 2 can suck the dust or blow the dust in a narrow space, and can be used conveniently.

As shown in FIG. 3 and FIG. 8, the second end 12 of the main body 10 is provided with clamping protrusive seat 101. The clamping protrusive seat 101 is hollow, and communicates with the ventilating chamber 16 and the outside of the main body 10. The clamping protrusive seat 101 can be cooperatively interlocked with ventilation adapting kit 110. The ventilation adapting kit 110 includes a plurality of ventilation adapting members connected to each other. The ventilation adapting members each include one end cooperatively interlocked with the clamping protrusive seat 101, and the other end provided with adapting nozzle 1103. The adapting nozzles 1103 have different diameters. The adapting nozzle 1103 with a small diameter can be directly used to blow the air for the dust removal. A larger impact force of a blown airflow can remove the dust more effectively. The adapting nozzle 1103 with a large diameter is generally used to suck the air or blow the air for the dust removal, and can further be connected to second air tube 1104 with a smaller diameter. In an embodiment, the ventilation adapting kit includes three ventilation adapting members connected to each other, namely first adapting member 1100, second adapting member 1101, and third adapting member 1102. The adapting nozzle 1103 of the first adapting member 1100 has a minimum diameter, and is mainly used to blow the air for the dust removal. The adapting nozzle 1103 of the second adapting member 1101 has an intermediate diameter, and can be used to blow the air or suck the air for the dust removal. The adapting nozzle 1103 of the third adapting member 1102 has a maximum diameter, and can be used to suck the air or blow the air for the dust removal. The adapting nozzle of the third adapting member can further be connected to the second air tube 1104 with the smaller diameter, and blows the air through the second air tube 1104 for the dust removal. According to an actual need, one of the adapting members can be selected and interlocked with the clamping protrusive seat 101 for the dust removal. In an embodiment, the clamping protrusive seat 101 is inserted into the third adapting member 1102. The adapting nozzle of the third adapting member 1102 is interlocked with the second air tube 1104. In a direction from the first end 11 to the second end 12 of the main body 10, the diameter of the second air tube 1104 is gradually decreased, such that an airflow blown from the second air tube 1104 has a large impact force to achieve a high dust removal efficiency.

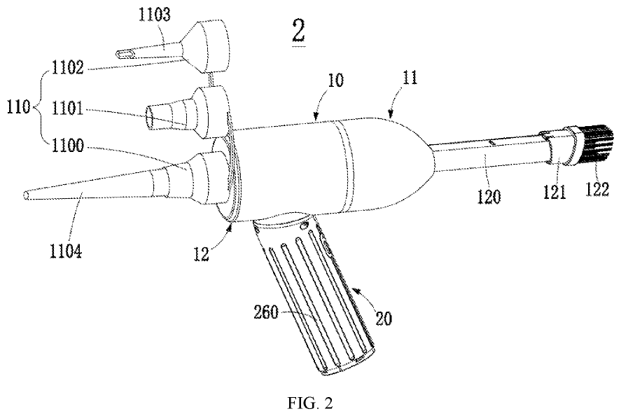

As shown in FIG. 1, FIG. 2 and FIG. 8, the handle 20 is rotatably connected to the main body 10, such that the handle 20 can be switched between a first position and a second position. The central axis of the handle 20, a central axis of the main body 10, and a rotating axis for rotation of the handle 20 relative to the main body 10 are coplanar. When the handle 20 is located at the first position, a central axis of the first air vent 13 is formed into an obtuse angle with the central axis of the handle 20. It may also be understood that an air blowing direction or an air sucking direction of the first air vent 13 is formed into an obtuse angle with an extension direction of the handle 20. In this case, an end of the handle 20 away from the main body 10 is adjacent to a side with the second air vent 14. When the handle 20 is located at the second position, a central axis of the second air vent 14 is formed into an obtuse angle with the central axis of the handle 20. It may also be understood that an air blowing direction or an air sucking direction of the second air vent 14 is formed into an obtuse angle with the extension direction of the handle 20. In this case, the end of the handle 20 away from the main body 10 is adjacent to a side with the first air vent 13. The first air vent 13 or the second air vent 14 may be selected by the operator for the dust removal. When the first air vent 13 is used for the dust removal, the handle 20 can rotate to the first position relative to the main body 10. When the second air vent 14 is used for the dust removal, the handle 20 can rotate to the second position relative to the main body 10. In both cases, during the dust removal, the handle 20 can be held by the operator with the high comfort level and the good user experience.

As shown in FIG. 8, in an embodiment, the main body 10 is composed of a plurality of components. That is, the main body 10 includes main shell 15, protective cover 160, filter screen 170, and rear cover 180. The motor 1500 and the impeller 1501 are provided in the main shell 15. The protective cover 160 includes one end connected to the main shell 15, and the other end connected to the filter screen 170. An end of the filter screen 170 away from the protective cover 160 is connected to the rear cover 180. The rear cover 180 is connected to the main shell 15. The plurality of components are accommodated in the main shell 15. The first end 11 and the first air vent 13 are provided on the rear cover 180. The second end 12 and the second air vent 14 are located on the main shell 15. The clamping protrusive seat 101 is provided at an end of the main shell 15 away from the rear cover 180. Sequentially passing through the filter screen 170, the protective cover 160, and a fan, the airflow is finally discharged from the main shell 15. In addition, the filter screen 170 can filter impurities sucked to the airflow. Protective guard 1600 on the protective cover 160 can further obstruct impurities in a filtered airflow, such that an airflow blown from the second air vent 14 is cleaner. When the second air vent 14 is used to blow the air for the dust removal, no new impurities are introduced.

As shown in FIG. 1 and FIG. 2, the handle 20 is rotatably connected to the main body 10 through a plurality of structures, for example, through a universal spherical body. In this case, the rotating axis for the handle 20 relative to the main body 10 is not fixed. A rotating track of the handle 20 can constitute at least one part of one spherical body. The handle 20 may also be rotatably connected to the main body 10 through a pin shaft or a self-locking shaft. In this case, the rotating axis for the handle 20 relative to the main body 10 is fixed. A rotating track of the handle 20 can constitute at least one part of one conical surface. In an embodiment, the handle 20 is rotatably connected to the main body 10 through clamping member 1401. The rotating axis serves as a central axis of the clamping member 1401. The handle 20 is rotatably connected to the main body 10 through rotary clamping. The rotating axis for the rotation of the handle 20 relative to the main body 10 may be intersected with the central axis of the main body 10. In a preferred embodiment, the rotating axis for the rotation of the handle 20 relative to the main body 10 and the central axis of the main body 10 are perpendicular to each other. The handle 20 at the first position and the handle 20 at the second position are symmetric with respect to a first plane. The first plane is perpendicular to the central axis of the main body and the rotating axis falls within the first plane. When the first end 11 and the second end 12 of the main body 10 are used for the dust removal, the handle 20 is held by the operator with the same experience.

When the handle 20 is rotatably connected to the main body 10 through the rotary clamping, one of the main body 10 and the handle 20 may include the clamping member 1401, and the other of the main body and the handle is provided with clamping groove 212. The clamping member 1401 and the clamping groove 212 can be clamped cooperatively and rotatably, such that the handle 20 and the main body 10 can rotate relatively.

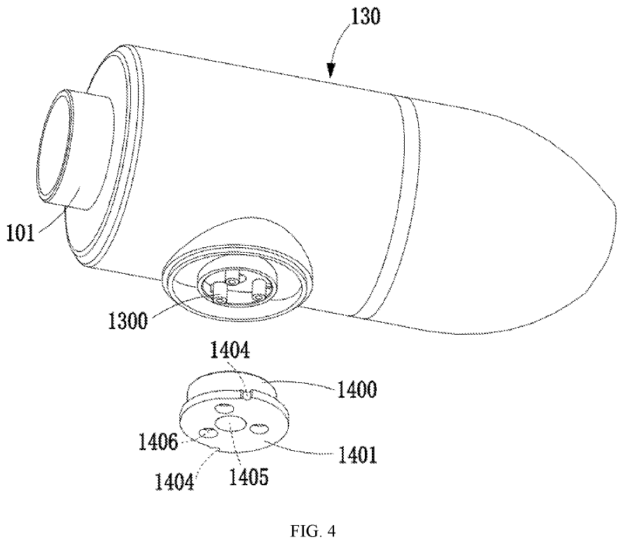

As shown in FIG. 4 and FIG. 5, in an embodiment, the main body 10 includes body 130 and connecting protrusive seat 140 that are connected to each other. The ventilating chamber 16 is formed in the body 130. One end of the connecting protrusive seat 140 may be integrally formed with, fixedly connected to or detachably connected to the body 130. In the embodiment, the connecting protrusive seat 140 is detachably connected to the body 130 through a screw, for ease of subsequent detachment and replacement of the connecting protrusive seat 140. Three first through holes 1406 are formed along a thickness direction of the connecting protrusive seat 140 in a penetration manner. The body 130 is correspondingly provided with three studs 1300. Threaded holes are respectively formed in the studs 1300. By allowing three screws to penetrate through the three first through holes 1406 and to be threadedly connected to the threaded holes of the studs 1300, the connecting protrusive seat 140 is connected to the body 130.

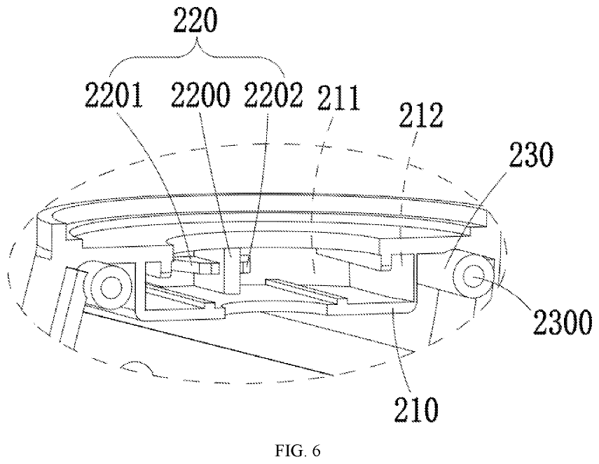

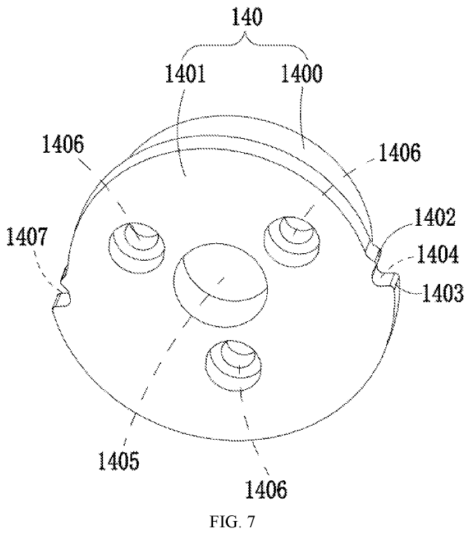

As shown in FIG. 5, FIG. 6 and FIG. 7, the connecting protrusive seat 140 includes seat body 1400 and the clamping member 1401. The seat body 1400 includes one end connected to the body 130, and the other end connected to the clamping member 1401. The clamping member 1401 is provided along a circumferential direction of the seat body 1400. The handle 20 is circumferentially provided with the clamping groove 212. The clamping member 1401 is clamped with the clamping groove 212, such that the handle 20 can rotate along the circumferential direction of the seat body 1400, and switched between the first position and the second position.

As shown in FIG. 5, FIG. 6 and FIG. 7, in an embodiment, the handle 20 includes mounting seat 210 adjacent to an end of the connecting protrusive seat 140. The mounting seat 210 extends toward the inside of the handle 20 in a direction of the rotating axis for the rotation of the handle 20 relative to the main body 10. The mounting seat 210 is provided with mounting groove 211 facing the connecting protrusive seat 140. The connecting protrusive seat 140 is provided in the mounting groove 211. The mounting groove 211 forms an inner peripheral surface on the mounting seat 210. The inner peripheral surface is circumferentially provided with the clamping groove 212. The handle 20 includes left half shell 200 and right half shell 201. Connecting post 230 is provided on the left half shell 200. Threaded hole 2300 is formed in the connecting post 230. The right half shell 201 is provided with second through hole 231 corresponding to the connecting post 230. By allowing a screw to penetrate through the second through hole 231 and to be threadedly connected to the threaded hole 2300 of the connecting post 230, the left half shell 200 may be connected to the right half shell 201. An end of each of the left half shell 200 and the right half shell 201 adjacent to the connecting protrusive seat 140 is provided with one part of the mounting seat 210. When the handle 20 and the main body 10 are connected, the clamping groove 212 of the mounting seat 210 of each of the left half shell 200 and the right half shell 201 is clamped onto the clamping member 1401 of the connecting protrusive seat 140, and then the left half shell 200 and the right half shell 201 are connected with a screw. Therefore, the handle 20 is connected to the main body 10, and the handle 20 can rotate relative to the main body 10.

As shown in FIG. 5, FIG. 7 and FIG. 8, circuit board 250 is further provided in the handle 20. Control button 240 is provided on the handle 20. The control button 240 is electrically connected to the circuit board 250. Wire hole 1405 is formed in a middle of the connecting protrusive seat 140. The wire hole 1405 communicates with the ventilating chamber 16 of the main body 10 and the inside of the handle 20. The circuit board 250 is connected to the drive assembly 150 in the ventilating chamber 16 through a lead via the wire hole 1405. The control button 240 can be manually controlled by the operator, so as to control the drive assembly 150 to work or shut down, thereby driving the first air vent 13 and the second air vent 14 to blow the air or suck the air for the dust removal.

In an embodiment, the housing 1 further includes a locating structure. When the handle 20 is located at the first position and the second position, the locating structure can limit the handle 20 and the main body 10 to rotate relatively. Consequently, when the handheld blowing-suction integrated dust remover 2 is used by the operator, the handle 20 does not rotate relative to the main body 10 to affect use.

The locating structure includes locating member 220 provided on one of the mounting seat 210 and the connecting protrusive seat 140, and a locating groove formed in the other of the mounting seat and the connecting protrusive seat. The locating member 220 can be cooperatively clamped with or separated from the locating groove. Through cooperative clamping between the locating member 220 and the locating groove, the handle 20 can be fixed at the first position or the second position. When the locating member 220 is separated from the locating groove, the handle 20 can rotate relative to the main body 10, so as to be switched between the first position and the second position.

As shown in FIG. 5, FIG. 6 and FIG. 7, in an embodiment, the locating member 220 is provided in the mounting groove 211, and the locating groove is formed in the clamping member 1401. In the embodiment, the locating member 220 includes fixed seat 2200, first clamping member 2201, and second clamping member 2202. The first clamping member 2201 and the second clamping member 2202 are respectively provided at a left side and a right side of the fixed seat 2200. There are two locating grooves, namely first locating groove 1404 and second locating groove 1407. The two locating grooves are oppositely provided on the clamping member 1401, namely a straight line connecting the two locating grooves passes through a center of the clamping member 1401. The two locating grooves correspond to two locating members 220 on a rotating path of the clamping member 1401. When the handle 20 is located at the first position, the first locating groove 1404 is cooperatively clamped with the first clamping member 2201, such that the handle 20 and the main body 10 are fixed relatively. When the handle 20 is located at the second position, the second locating groove 1407 is cooperatively clamped with the second clamping member 2202, such that the handle 20 and the main body 10 are fixed relatively. It is to be noted that an opening direction of the first locating groove 1404 and an opening direction of the second locating groove 1407 face to a same side. When switched between the first position and the second position, the handle 20 rotates back and forth in a range of 180°.

As shown in FIG. 5, FIG. 6 and FIG. 7, the first locating groove 1404 and the second locating groove are structurally the same. The first locating groove 1404 is further described below, and descriptions on the second locating groove are the same. First locating flange 1402 and second locating flange 1403 are provided on a side peripheral surface of the clamping member 1401. The first locating groove 1404 is formed between the first locating flange 1402 and the second locating flange 1403. The first locating groove 1404 is recessed toward the side peripheral surface of the clamping member 1401. The second locating flange 1403 is farther to the center of the clamping member 1401 than the first locating flange 1402. When the first locating groove 1404 is clamped with the first clamping member 2201, the first clamping member 2201 first abuts against the first locating flange 1402. The clamping member 1401 may be made of an elastic material, such as a hard plastic. While overcoming a deformation damping force of the first locating flange 1402 and getting over the first locating flange 1402, a locating post is clamped with the first locating groove 1404. The first locating flange 1402 and the second locating flange 1403 limit the first clamping member 2201 at the same time, thereby limiting the handle 20 and the main body 10 to rotate relatively. A same clamping manner is provided between the second locating groove and the second locating member 220, and will not be repeated herein.

As shown in FIG. 1, in an embodiment, a plurality of antislip stripes are provided circumferentially at an outer side of the handle 20. The antislip stripes are used to increase a frictional force with a hand of the operator, so as to take an antislip effect. Therefore, the handheld blowing-suction integrated dust remover 2 can be stably held by the operator, and does not fall off easily in use.

The present disclosure is described above with reference to several typical implementations. It should be understood that the terms used herein are intended for illustration, rather than limiting. The present disclosure may be specifically implemented in many forms without departing from the spirit or essence of the present disclosure. Therefore, it should be understood that the above embodiments are not limited to any of the above-mentioned details, but should be broadly interpreted according to the spirit and scope defined by the appended claims. Therefore, any changes and modifications falling within the claims or the equivalent scope thereof should be covered by the appended claims.

What is claimed is:

1. A handheld blowing-suction integrated dust remover, comprising:
a main body, wherein a first air vent and a second air vent are respectively formed at two opposite ends of the main body, a ventilating chamber is formed in the main body, both the first air vent and the second air vent communicate with the ventilating chamber and an outside of the main body, and the first air vent and the second air vent are respectively connected to elongated air tubes;
a handle connected to the main body, where the handle is formed into an included angle with the main body to be held conveniently; and
a drive assembly provided in the ventilating chamber and configured to utilize the elongated air tubes at two sides to drive one of the first air vent and the second air vent to suck air, and the other of the first air vent and the second air vent to blow air.

2. The handheld blowing-suction integrated dust remover according to claim 1, wherein the main body comprises a first end and a second end, wherein the first end and the second end are opposite to each other; the first air vent is formed at the first end; the second air vent is formed at the second end; the handheld blowing-suction integrated dust remover comprises a first elongated air tube and a second elongated air tube; an end of the first elongated air tube is detachably connected to the first end, and the first elongated air tube communicates with the first air vent; an end of the second elongated air tube is detachably connected to the second end, and the second elongated air tube communicates with the second air vent.

3. The handheld blowing-suction integrated dust remover according to claim 2, wherein the end of the first elongated air tube is clamped at the first end, and the end of the second elongated air tube is clamped at the second end, such that the first elongated air tube and the second elongated air tube are detachably connected to the main body, respectively; and alternatively, the end of the first elongated air tube is threadedly connected to the first end, and the end of the second elongated air tube is threadedly connected to the second end, such that the first elongated air tube and the second elongated air tube are detachably connected to the main body, respectively.

4. The handheld blowing-suction integrated dust remover according to claim 3, wherein the second end of the main body is provided with a clamping protrusive seat; the clamping protrusive seat is hollow and communicates with the ventilating chamber and the outside of the main body; the second air vent is formed at an end of the clamping protrusive seat; the handheld blowing-suction integrated dust remover comprises a ventilation adapting kit; the ventilation adapting kit is hollow and cooperatively inserted into the clamping protrusive seat; the second elongated air tube is inserted into the ventilation adapting kit; the ventilation adapting kit comprises a plurality of ventilation adapting members connected to each other; each of the plurality of ventilation adapting members comprises a first end configured to be interlocked with the clamping protrusive seat, and a second end provided with an adapting nozzle; the adapting nozzles have different diameters; and the second elongated air tube is configured to be interlocked with a well-matched adapting nozzle to communicate with the second air vent.

5. The handheld blowing-suction integrated dust remover according to claim 3, wherein the main body is provided with a connecting groove; the connecting groove communicates with the ventilating chamber and the outside of the main body; the first air vent is formed at a rabbet of the connecting groove; and the first elongated air tube is inserted into the connecting groove.

6. The handheld blowing-suction integrated dust remover according to claim 1, wherein in a direction of each of the first end and the second end of the main body, an outer diameter of at least one of the elongated air tubes is gradually decreased from a side adjacent to the main body towards a side away from the main body.

7. The handheld blowing-suction integrated dust remover according to claim 1, wherein the drive assembly comprises a motor and an impeller; and the motor drives the impeller to rotate, thereby bringing outside air to the main body to form air suction, or discharging an airflow in the main body to the outside to form air blowing.

8. The handheld blowing-suction integrated dust remover according to claim 1, wherein the handheld blowing-suction integrated dust remover comprises a filter screen; the filter screen is provided in the main body and located between the drive assembly and the first air vent; and when the drive assembly drives outside air to enter the main body, the filter screen filters impurities in the air, such that an airflow is discharged out of the main body through the drive assembly.

9. The handheld blowing-suction integrated dust remover according to claim 8, further comprising a protective cover, wherein the protective cover is provided in the main body and located between the drive assembly and the filter screen; the protective cover is provided with a protective guard; and the protective guard filters gas passing through the filter screen.

10. A handheld blowing-suction integrated dust remover, comprising:
a main body, wherein a first air vent and a second air vent are respectively formed at two opposite ends of the main body, a ventilating chamber is formed in the main body, and both the first air vent and the second air vent communicate with the ventilating chamber and an outside of the main body;
a handle connected to the main body, where the handle is formed into an included angle with the main body to be held conveniently;
a drive assembly provided in the ventilating chamber and configured to drive one of the first air vent and the second air vent to suck air, and the other of the first air vent and the second air vent to blow air; and
an air tube, wherein the air tube is elongated, an end of the air tube is detachably connected to the first air vent, and the air tube is further configured to be separated from the first air vent and detachably connected to the second air vent.

11. A dust remover, comprising:
a main body, wherein a first air vent and a second air vent are respectively formed at two opposite ends of the main body, a ventilating chamber is formed in the main body, and both the first air vent and the second air vent communicate with the ventilating chamber and an outside of the main body; and
a handle, wherein the handle is rotatably connected to the main body, such that the handle is configured to be switched between a first position and a second position; when the handle is located at the first position, a central axis of the first air vent is formed into an obtuse angle with a central axis of the handle, and an end of the handle away from the main body is adjacent to a side with the second air vent; when the handle is located at the second position, a central axis of the second air vent is formed into an obtuse angle with the central axis of the handle, and the end of the handle away from the main body is adjacent to a side with the first air vent; and at the first position and the second position, the central axis of the handle, a central axis of the main body, and a rotating axis for rotation of the handle relative to the main body are coplanar.

12. The dust remover according to claim 11, wherein the rotating axis and the central axis of the main body are perpendicular to each other; the handle at the first position and the handle at the second position are symmetric with respective to a first plane; and the first plane is perpendicular to the central axis of the main body and the rotating axis falls within the first plane.

13. The dust remover according to claim 11, wherein one of the main body and the handle comprises a clamping member, and the other of the main body and the handle is circumferentially provided with a clamping groove; and the clamping member is cooperatively clamped with the clamping groove, such that the handle is rotatably connected to the main body.

14. The dust remover according to claim 13, wherein the main body comprises a body and a connecting protrusive seat, wherein the body and the connecting protrusive seat are connected to each other; the ventilating chamber is formed in the body; the connecting protrusive seat comprises a seat body and the clamping member provided along a circumferential direction of the seat body; and the handle is circumferentially provided with the clamping groove.

15. The dust remover according to claim 14, wherein the handle comprises a mounting seat adjacent to an end of the connecting protrusive seat; the mounting seat is provided with a mounting groove facing the connecting protrusive seat; the connecting protrusive seat is provided in the mounting groove; the mounting groove forms an inner peripheral surface on the mounting seat; and the inner peripheral surface is circumferentially provided with the clamping groove.

16. The dust remover according to claim 15, wherein the dust remover further comprises a locating structure; the locating structure comprises a locating member provided in the clamping groove; the clamping member is provided with a first locating groove and a second locating groove; and the handle is configured to rotate relative to the main body and drive the locating member to be clamped with the first locating groove or the second locating groove, such that the handle is limited at the first position or the second position.

17. The dust remover according to claim 16, wherein the locating member comprises a fixed seat, a first clamping member, and a second clamping member; the first clamping member and the second clamping member are respectively symmetrically provided at a left side and a right side of the fixed seat; a straight line connecting the first locating groove and the second locating groove passes through a central axis of the clamping member; when the first clamping member is clamped with the first locating groove, the handle is located at the first position; and when the second clamping member is clamped with the second locating groove, the handle is located at the second position.

18. The dust remover according to claim 11, wherein the dust remover comprises a universal spherical body, wherein the universal spherical body is provided between the main body and the handle, and the handle is configured to drive the universal spherical body to rotate at a plurality of angles relative to the main body.

19. A dust remover, comprising:
a main body, wherein a first air vent and a second air vent are respectively formed at two opposite ends of the main body, a ventilating chamber is formed in the main body, and both the first air vent and the second air vent communicate with the ventilating chamber and an outside of the main body; and
a handle, wherein the handle is rotatably connected to the main body, such that the handle is configured to be switched between a first position and a second position; when the handle is located at the first position, a central axis of the first air vent is formed into an obtuse angle with an extension direction of the handle, and an end of the handle away from the main body is adjacent to a side with the second air vent; when the handle is located at the second position, a central axis of the second air vent is formed into an obtuse angle with the extension direction of the handle, and the end of the handle away from the main body is adjacent to a side with the first air vent; and when the handle is switched from one position to the other position in the first position and the second position, a movement track of a central axis of the handle constitutes at least one part of a conical surface.

20. The dust remover according to claim 19, wherein when the handle rotates from one position to the other position in the first position and the second position, the movement track of the central axis of the handle constitutes one half of the conical surface; and alternatively, the handle is configured to rotate back and forth in a range of 180° to be switched between the first position and the second position.
